(19) United States
(12) Patent Application Publication
(10) Pub. No.: US 2017/0008766 A1
(43) Pub. Date: Jan. 12, 2017

(54) SYNTHESIS OF BORON NITRIDE AND COATING METHOD OF THE SAME

(71) Applicant: KOREA INSTITUTE OF ENERGY RESEARCH, Daejeon (KR)

(72) Inventors: In Sub HAN, Nonsan-si (KR); Se Young KIM, Daejeon (KR); Hyun Uk KIM, Daejeon (KR); Young Hoon SEONG, Daejeon (KR); Sang Kuk WOO, Daejeon (KR); Hee Yeon KIM, Daejeon (KR); Doo Won SEO, Daejeon (KR); Min Soo SUH, Daejeon (KR); Seong OK HAN, Daejeon (KR)

(73) Assignee: KOREA INSTITUTE OF ENERGY RESEARCH, Daejeon (KR)

(21) Appl. No.: 15/203,800

(22) Filed: Jul. 7, 2016

(30) Foreign Application Priority Data
Jul. 7, 2015 (KR) 10-2015-0096448

(51) Int. Cl. C01B 21/064; B05D 1/18

(52) U.S. Cl. CPC C01B 21/064; B05D 1/18

(57) ABSTRACT

Provided is a method of synthesizing boron nitride, comprising the steps of: preparing a boron compound and a nitrogen compound; mixing the boron compound and the nitrogen compound in a non-aqueous solvent; forming an ester compound by melting the mixture in the non-aqueous solvent; dehydrating the ester compound; and forming boron nitride by nitriding the ester compound in a reductive atmosphere.

### CROSS-REFERENCE TO RELATED APPLICATION

This application claims priority to and the benefit of Korean Patent Application No. 10-2015-0096448, filed on Jul. 7, 2015, the disclosure of which is incorporated herein by reference in its entirety.

### BACKGROUND OF THE INVENTION

Field of the Invention

The present invention relates to a synthesis of boron nitride and a coating method of the same, and more particularly, to a method of synthesizing boron nitride by using a boric acid and urea as starting materials and a method of coating boron nitride.

Description of the Related Art

A carbon fiber-silicon carbide composite material or silicon carbide fiber-silicon carbide composite is known as an excellent thermal and mechanical structural material due to high temperature strength, fracture toughness, and chemical stability. In such a fiber-reinforced composite material, crack deflection in an interphase between a fiber phase and a matrix phase is the more important factor of increasing fracture toughness of the composite material. In such a carbon fiber-silicon carbide composite material or silicon carbide fiber-silicon carbide composite, interphase coating has a problem in that generally, pyrolytic carbon (PyC) coating is basically applied, but pyrolytic carbon has a characteristic which is easily oxidized even at a low temperature to deteriorate a mechanical property of the composite material.

Accordingly, in order to increase oxidation resistance of the fiber-reinforced composite material, boron nitride (BN) having a similar crystal structure to the pyrolytic carbon has been researched as an alternative material of the pyrolytic carbon. In the case of coating the fiber interphase with the boron nitride, as oxidation is starts at 800° C., the boron nitride has an advantage of having excellent oxidation resistance as compared with the pyrolytic carbon in which oxidation starts around 400° C. Further, when oxidation is in progress, the boron nitride forms boron oxide (B₂O₃) on the fiber interphase and the formed boron oxide have a feature having a self-healing function at a high temperature and thus, fiber interphase control coating may be the most proper method.

Until now, the most general coating method of boron nitride is a chemical vapor deposition (CVD) method. However, the coating by the CVD method needs to use gas which is expensive and contains toxic components, such as boron trichloride (BCl₃), boron trifluoride (BF₃) or ammonia (NH₃), hydrogen (H₂). In order to obtain a uniform coating layer, gas flow or pressure control is very difficult and expensive equipment is required, and thus the method is limited to be application as a fiber coating process.

The CVD method described in document (Ceramic Engineering and Science Proceedings 18, pages 287 to 294, in 1997) is a method of coating the fiber by decomposing gas which is a source of a coating material at a temperature of approximately 900 to 1100° C., and when the thermal and mechanical stress is applied to the matrix, the fiber does not support the stress or effectively suppresses the propagation of the cracks to be damaged or broken. The fiber has relatively higher elastic coefficient and mechanical strength than the matrix to have a high possibility to be damaged under a predetermined load. If the fiber effectively alleviates the stress, the lifespan of the fiber-reinforced composite may be further enhanced. Meanwhile, there is a problem in that an existing coating layer is lost at a high temperature of 600° C. or more and there is a problem in that in many cases, the existing coating layer is coated by selecting one kind of a coating material or uneconomically coated by selecting multiple coating materials.

### SUMMARY OF THE INVENTION

In order to solve the problems, an object of the present invention is to provide a method of synthesizing and coating boron nitride with low price by using an esterification reaction instead of using expensive and toxic gas.

An aspect of the present invention provides a method of synthesizing boron nitride, comprising the steps of: preparing a boron compound and a nitrogen compound (S10); mixing the boron compound and the nitrogen compound in a non-aqueous solvent (S20); forming an ester compound by melting the mixture in the non-aqueous solvent (S30); dehydrating the ester compound (S40); and forming boron nitride by nitriding the ester compound in a reductive atmosphere (S50).

Another aspect of the present invention provides a method of coating boron nitride, comprising the steps of: forming an ester-based boron nitride precursor by mixing a nitrogen compound and a boron compound in a non-aqueous solvent; melting the ester-based boron nitride precursor in alcohol; dipping a coating fiber in the alcohol; drying the coating fiber; and nitriding the coating fiber coated with the ester-based boron nitride precursor.

### BRIEF DESCRIPTION OF THE DRAWING(S)

FIG. 1 is a procedure diagram illustrating a process of synthesizing boron nitride according to an exemplary embodiment of the present invention; and

FIG. 2 is a procedure diagram illustrating a process of coating boron nitride according to another exemplary embodiment of the present invention.

### DETAILED DESCRIPTION OF THE PREFERRED EMBODIMENT(S)

Hereinafter, the present invention will be described with reference to the accompanying drawings. As those skilled in the art would realize, the described embodiments may be modified in various different ways, all without departing from the spirit or scope of the present invention. Parts which are not related with the description are omitted in order to clearly describe the present invention in the drawings and like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Hereinafter, exemplary embodiments of the present invention will be described in detail with reference to the accompanying drawings.

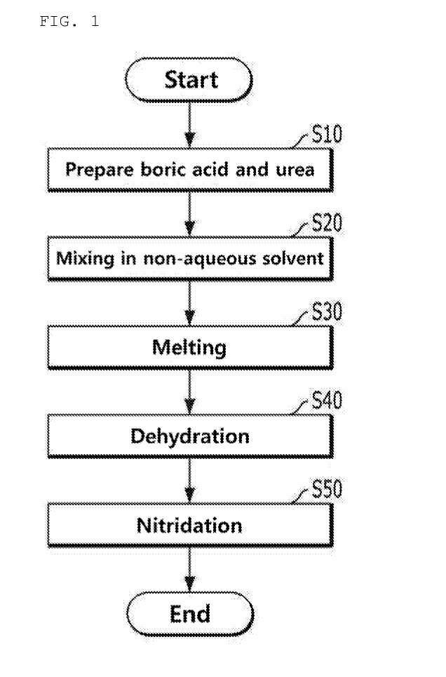

FIG. 1 is a procedure diagram illustrating a process of synthesizing boron nitride according to an exemplary embodiment of the present invention.

Referring to FIG. 1, a step of mixing urea (CO(NH₂)₂) containing an amine group (NH₂) and boric acid (H₃BO₃) may be performed.

As a material containing boron used in the present invention, various compounds including boric acid, boron oxide, borates of inorganic or organic compounds, halogenated boron, borazine, borosiloxane, and the like may be used. However, a boron compound having Formula (B₂O₃)(H₂O)ₓ (however, x=0 to 3) including boric acid, boron oxide, a borate of alkali metal or an alkaline earth metal (for example, borax), and the like may be economic and properly used.

As boric acid and boron oxide, one or two or more of compounds including orthoboric acid (H₃BO₃), metaboric acid (HBO₃), tetra boric acid (H₂B₄O₇), boric anhydride (B₂O₃), and the like are suitable.

A nitrogen-containing material used in the present invention may be a material containing a nitrogen atom in the molecule. An organic nitrogen compound, an inorganic nitrogen compound, a nitrogen group, and a mixture thereof may be used.

As the organic nitrogen compound among the nitrogen-containing material, various materials may be used, but in terms of the nitrogen content, economics, responsiveness, etc., an organic compound having a NH2 group such as melamine and urea, an organic ammonium salt, an amide compound, an organic compound having a N≡C-group, and the like are suitable. Among them, melamine (C₃H₆N₆) and urea (CO(NH₂)₂) may be particularly preferably used. As the inorganic nitrogen compound among the nitrogen-containing materials, ammonia gas, an ammonium salt of an alkali metal or an alkaline earth metal, and the like may be exemplified.

The nitrogen-containing material formed of the solid phase and the boron containing material are mixed to be melted in a non-aqueous solvent such as alcohol, toluene, and xylene (S20 and S30). The toluene means that a hydrogen group is substituted to a methyl group in benzene and the xylene means a form in which two hydrogen groups are substituted to the methyl group, such as ortho-, meta-, and para-.

Polyborate (hereinafter, referred to as polyborate) may mean that boron oxide (B₂O₃) is partially esterified. More particularly, at least two borons (Bs) may be included. The borons (Bs) may be connected to each other through O. Furthermore, the borons (Bs) may include at least one borate ester group. The aforementioned polyborate may be a product of a reaction of the nitrogen compound containing amines and the boron compound.

In more detail, the borate ester may be formed through a reaction of Reaction Formula 1.

[Reaction Formula 1]

B(OH)₃+3R(OH)→B(OR)₃+3(H₂O)

That is, the borate ester may be a polymer compound formed through a condensation reaction of the boron compound and alcohol. R may be an alkyl group or an aryl group.

As verified in Reaction Formula 1, since a byproduct formed by the reaction of the boron compound and the alcohol is included, a dehydrating agent capable of removing water as the byproduct may be used (S40). As the dehydrating agent, high-concentrated sulfuric acid (H2SO4) may be used. The borate ester may be purified through distillation due to volatility.

Herein, a molar ratio of the boron compounding containing boron and the nitrogen compound containing nitrogen may be 1:0.5 to 1:2. When the molar ratio is smaller than 1:0.5, a large amount of boron compound remains, and when the molar ratio is larger than 1:2, a large amount of nitrogen compound remains. As such, when a large amount of boron compound or nitrogen compound remains, a large amount of byproduct is generated in the heat-treatment process and thus a failure may occur in the formation of boron nitride (BN).

The boron-containing material and the nitrogen-containing material react with each other to obtain a boron nitride precursor having a polyborate ester structure.

As described above, the boron-containing material contains a H₂O group and thus may be subjected to a dehydration process (S40). Through the dehydration process, generation and collection of bubbles caused by vapor which is a problem which may occur in the process of forming the BN may be prevented.

The borate ester may be formed by heating boric acid or through a reaction with boron oxide (B₂O₃) in a dehydration condition. The borate ester may be called a precursor which is formed through a chemical synthesis at an ammonia or nitrogen atmosphere of the BN.

With respect to the borate ester formed above, a coupling reaction of the nitrogen compound and the polyborate ester may be induced at a high temperature of 1,000 to 1,300° C. (S50).

The coupling reaction of the nitrogen compound and the polyborate may be performed in a nitrogen pressure atmosphere. When the reaction is generated at a lower temperature than 1,000° C., a formation rate of the boron nitride may be decreased. When the reaction is performed at a higher temperature than 1,300° C., high-temperature energy needs to be supplied and thus there is a problem in economics.

A nitriding process through the formation of the polyborate ester of the boron nitride may be applied even to application of the fiber-reinforced composite. The fiber-reinforced composite may be a form in which boron nitride as a fiber material is formed on a surface layer of the carbon fiber or the silicon carbide fiber.

In the related art, in order to form the fiber reinforced composite, generally, a chemical vapor deposition (CVD) method is used. In the case of using the CVD process, it is difficult to use toxic gas and form the uniform coating layer as described above.

Meanwhile, a method of forming a fiber-reinforced composite according to an exemplary embodiment of the present invention may include steps of forming an ester-based boron nitride precursor by mixing a nitrogen compound and a boron compound in a non-aqueous solvent, melting the ester-based boron nitride precursor in alcohol, dipping a coating fiber in the alcohol, drying the coating fiber, and nitriding the coating fiber coated with the ester-based boron nitride precursor.

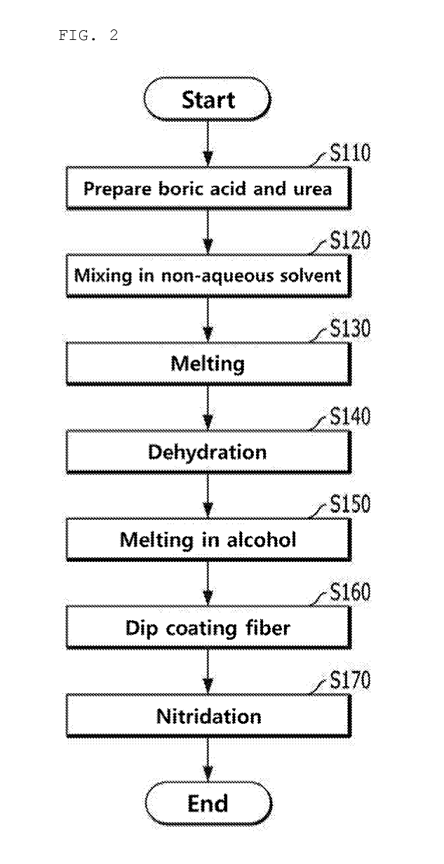

More particularly, the method will be described below with reference to FIG. 2.

FIG. 2 is a procedure diagram illustrating a process of coating boron nitride according to another exemplary embodiment of the present invention.

Referring to FIG. 2, basically, a mixture of boron and urea as a boron compound may be prepared (S110). The boron may be a compound containing a boron group and the urea may be a compound containing an amine group.

The boron nitride according to the exemplary embodiment of the present invention may be formed by nitriding a polyborate ester polymer precursor as a compound of the urea and the boron.

Herein, the polyborate ester polymer precursor may be a compound in which boron oxide (B₂O₃) is partially esterified.

In order to form such a polyborate ester polymer precursor, a process of melting the boron and the urea in alcohol, toluene, or xylene as the non-aqueous solvent may be performed (S120 and S130). During the process of melting the boron, the polyborate ester may be formed as an intermediate transition compound. In the same manner as the process of forming boron nitride powder, a process of removing a H₂O group bound to the boron compound may be performed (S140). In order to perform such a process, sulfuric acid may be used as described above.

The process of melting the polyborate ester polymer precursor in the alcohol through the dehydration process may be performed (S150). The polyborate ester polymer precursor contains an ester group and thus, dissolution for the non-aqueous solvent such as alcohol may be easily performed.

A process of melting a carbon-based fiber or a silicon carbide-based fiber in the alcohol in which the polyborate ester polymer precursor is melted may be performed.

An immersing process for the fiber to be coated may be performed as a dipping process (S160). A process of removing an alcohol group attached to the coating fiber through the drying process may be performed. The polyborate ester may be bounded on the surface of the coating fiber preparing through the drying process by van der Waals force which is physical binding force.

A BN compound may be formed on the surface of the carbon-based fiber or the silicon carbide-based fiber by nitriding the dried polyborate ester polymer at 1,000 to 1,300° C. in a nitrogen atmosphere.

As such, in the case where the BN compound is formed on the surface of the carbon-based fiber or the silicon carbide-based fiber, the method of coating the boron nitride fiber may have an advantage of forming the coating layer without a limitation to a shape or a size of a molding body.

In such a process, a preparing method is facilitated as compared with the existing silicon nitride coating layer preparing the compacting (molding) and heat treatment and a fiber coating process may be simplified and processing cost may be innovatively reduced.

According to the embodiment of the present invention, the carbon fiber or silicon carbide fiber reinforced ceramic composite is coated on the surface of the fiber to contribute to the enhanced physical property of the composite material by protecting an interphase between the matrix and the fiber.

The effects of the present invention are not limited to the above effects and it should be understood that the effects include all effects inferable from the configuration of the invention described in the detailed description or claims of the present invention.

The aforementioned description of the present invention is to be exemplified, and it can be understood to those skilled in the art that the technical spirit or required features of the present invention can be easily modified in other detailed forms without changing. The scope of the technical concept of the present disclosure is not limited thereto. For example, respective constituent elements described as single types can be distributed and implemented, and similarly, constituent elements described to be distributed can be also implemented in a coupled form.

While the present invention has been described with respect to the specific embodiments, it will be apparent to those skilled in the art that various changes and modifications may be made without departing from the spirit and scope of the invention as defined in the following claims.

What is claimed is:

1. A method of synthesizing boron nitride, the method comprising the steps of:
preparing a boron compound and a nitrogen compound;
mixing the boron compound and the nitrogen compound in a non-aqueous solvent;
forming an ester compound by melting the mixture in the non-aqueous solvent;
dehydrating the ester compound; and
forming boron nitride by nitriding the ester compound in a reductive atmosphere.

2. The method of synthesizing the boron nitride of claim 1, wherein the boron compound includes boric acid (H₃BO₃).

3. The method of synthesizing the boron nitride of claim 1, wherein the nitrogen compound includes melamine (C₃H₆N₆) or urea (CO(NH₂)₂).

4. The method of synthesizing the boron nitride of claim 1, wherein the non-aqueous solvent includes alcohol, toluene, or xylene.

5. The method of synthesizing the boron nitride of claim 1, wherein the ester compound includes a polyborate ester precursor.

6. The method of synthesizing the boron nitride of claim 1, wherein the reductive atmosphere includes a nitrogen atmosphere and the nitriding is performed at 1,000 to 1,300° C.

7. The method of synthesizing the boron nitride of claim 1, wherein the boron compound and the nitrogen compound have a molar ratio of 1:0.5 to 1:2.

8. The method of synthesizing the boron nitride of claim 1, wherein the boron nitride ester precursor includes a R—O—B group and the R includes an alkyl group or an aryl group.

9. A method of coating boron nitride, the method comprising the steps of:
forming an ester-based boron nitride precursor by mixing a nitrogen compound and a boron compound in a non-aqueous solvent;
melting the ester-based boron nitride precursor in alcohol;
dipping a coating fiber in the alcohol;
drying the coating fiber; and
nitriding the coating fiber coated with the ester-based boron nitride precursor.

10. The method of coating the boron nitride of claim 9, wherein the coating fiber includes a carbon-based fiber or a silicon carbide-based fiber.

11. A fiber-reinforced composite comprising:
a matrix material containing a carbon-based fiber or a silicon carbide-based fiber; and
a coating layer containing boron nitride formed on the surface layer of the matrix material.

12. The fiber-reinforced composite of claim 11, wherein the coating layer containing the boron nitride includes a reactive coating layer of a boron compound containing boron and a nitrogen compound containing urea.

13. The fiber-reinforced composite of claim 11, wherein the reactive coating layer is formed by a nitriding reaction of the polymer precursor of the polyborate ester.

14. Crystalline boron nitride formed through a nitriding reaction with a polyborate ester polymer precursor as a compound of urea and boric acid.

15. The crystalline boron nitride of claim 14, wherein the polyborate ester polymer precursor is a compound in which boron oxide is partially esterified.
